(19) United States
(12) Patent Application Publication
(10) Pub. No.: US 2023/0156382 A1
(43) Pub. Date: May 18, 2023

(54) COMMUNICATION SYSTEM

(71) Applicant: NIPPON TELEGRAPH AND TELEPHONE CORPORATION, Tokyo (JP)

(72) Inventors: Tomoya HATANO, Musashino-shi, Tokyo (JP); Keita TAKAHASHI, Musashino-shi, Tokyo (JP)

(73) Assignee: NIPPON TELEGRAPH AND TELEPHONE CORPORATION, Tokyo (JP)

(21) Appl. No.: 17/911,758

(22) PCT Filed: Mar. 19, 2020
(86) PCT No.: PCT/JP2020/012366

§ 371 Date: Sep. 15, 2022

(51) Int. Cl. H04Q 11/00

(52) U.S. Cl. CPC H04Q 11/0067; H04Q 2011/0096

(57) ABSTRACT

One aspect of the present invention is a communication system for a passive optical network that includes: an OLT (optical line terminal); a first splitter configured to output an optical signal that is output from the OLT, to optical communication channels from a first port and a second port; a plurality of second splitters that are connected between the first port and second port of the first splitter using optical communication channels; and ONUs (optical network units) that are connected to the respective second splitters using optical communication channels.

### TECHNICAL FIELD

The present invention relates to a communication system technology.

### BACKGROUND ART

In a service for providing optical access, economical servicing is realized by using a passive optical network (PON) in which a terminal office apparatus and a plurality of terminal apparatuses are connected (refer to NPL 1, for example). The PON is a point-to-multipoint network in which a central office provides services to a large number of subscribers. For example, in the PON, a downstream optical signal from a central office is branched by an optical coupler connected to one trunk line fiber, and is distributed to a plurality of subscribers. In the PON, an ONU (Optical Network Unit) on a downstream side and an OLT (Optical Line Terminal) on a host side are used.

### Citation List

### Non Patent Literature

[NPL 1] “Technology Basic Course GE-OPON Technology”, [online], NTT GIJUTU Journal, 2005.8 pp.71-74, [Retrieved on Feb. 28, 2020], Internet “https://www.ntt.co.jp/journal/0508/files/jn200508071.pdf”

### SUMMARY OF THE INVENTION

### Technical Problem

However, there is a problem in that, in a known PON, it is difficult to maintain communication when a problem such as a facility failure occurs.

The present invention has been made in view of the problem described above, and an object of the present invention is to provide a technique for improving the likelihood of maintaining communication even in a case where a problem occurs in the PON.

### Means for Solving the Problem

One aspect of the present invention is a communication system for a passive optical network that includes; an OLT (Optical Line Terminal): a first splitter configured to output an optical signal that is output from the OLT, to optical communication channels from a first port and a second port; a plurality of second splitters that are connected between the first port and second port of the first splitter using optical communication channels; and ONUs (Optical Network Units) that are connected to the respective second splitters using optical communication channels.

### Effects of the Invention

According to the present invention, even if a problem occurs in the PON, the likelihood of maintaining communication can be increased.

### BRIEF DESCRIPTION OF DRAWINGS

FIG. 1 is a diagram illustrating an exemplary system configuration of a communication system 100 of the present invention.

FIG. 2 is a diagram illustrating an exemplary configuration of an OLT 20 and a first splitter 21.

FIG. 3 is a diagram illustrating an exemplary configuration of a second splitter 30 and an ONU 40.

FIG. 4 is a diagram illustrating a specific example of operations of the communication system 100 at a time of normal communication.

FIG. 5 is a diagram illustrating a specific example of operations of the communication system 100 at a time of troubled communication.

### DESCRIPTION OF EMBODIMENTS

An embodiment of the present invention will be described in detail with reference to the drawings.

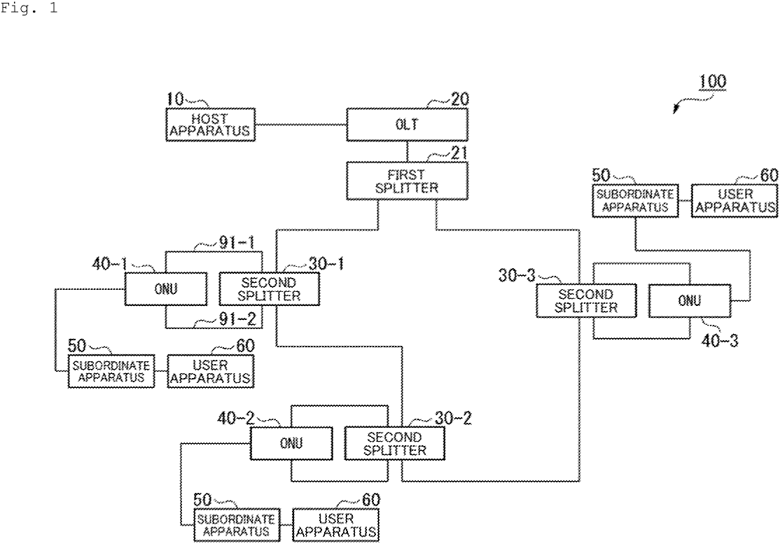

FIG. 1 is a diagram illustrating an exemplary system configuration of a communication system 100 of the present invention. The communication system 100 includes a host apparatus 10, an OLT 20, a first splitter 21, a plurality of second splitters 30, a plurality of ONUs 40, subordinate apparatuses 50 and user apparatuses 60. The host apparatus 10 is connected to a host network of the communication system 100. The first splitter 21 and the plurality of second splitters 30 are connected to a communication channel (hereinafter, referred to as a “trunk communication channel”) that is formed in a ring shape. In FIG. 1, three second splitters 30 and three ONUs 40 are illustrated, but the number “three” is merely a specific example. That is, the number of the second splitters 30 and the ONUs 40 need only be two or more.

The OLT 20 is installed so as to be able to communicate with the host apparatus 10. The OLT 20 functions as an OLT in the PON. The first splitter 21 receives an input of an optical signal from the OLT 20, and outputs the optical signal to the trunk communication channel through a plurality of paths. The first splitter 21 receives inputs of optical signals from the trunk communication channel through the plurality of paths, puts together the optical signals, and outputs the resultant signal to the OLT 20. The second splitters 30 each receive an input of an optical signal, and output the optical signal to a plurality of paths. The second splitters 30 are each configured using an optical splitter with two inputs and two outputs, for example.

The ONUs 40 are communicably connected to respective subordinate apparatuses 50. Each subordinate apparatus 50 is communicably connected to one or more user apparatuses 60. In the following, each apparatus will be described in detail. Note that, for the sake of description, the host apparatus 10, the subordinate apparatuses 50, and the user apparatuses 60 will be described prior to the description of the OLT 20, the first splitter 21, the second splitters 30, and the ONUs 40.

The host apparatus 10 is communicably connected to a plurality of subordinate apparatuses 50 via the OLT 20, the first splitter 21, the second splitters 30 and the ONUs 40. The host apparatus 10 is an apparatus that realizes a predetermined function by performing communication with the plurality of subordinate apparatuses 50. The host apparatus 10 is a base band unit (BBU) in a mobile network, for example. The host apparatus 10 may also be a communication device that constitutes a relay network, for example.

Each subordinate apparatus 50 is an apparatus that realizes a predetermined function by performing communication with the host apparatus 10. The subordinate apparatus 50 is an apparatus that is installed at a position closer to a user side than the host apparatus 10 is. For example, when the host apparatus 10 is a BBU, the subordinate apparatus 50 is a remote radio head (RRH) in a mobile network. In this case, the communication channel between the subordinate apparatus 50 and the corresponding user apparatus 60 is an access section of the mobile network. On the other hand, when the host apparatus 10 is a communication device that constitutes a relay network, the subordinate apparatus 50 may also be an apparatus such as a set-top box. In this case, the communication channel between the subordinate apparatus 50 and the corresponding user apparatus 60 may also be a network such as a home network. The subordinate apparatus 50 houses one or more user apparatuses 60, for example. Note that the configuration may also be such that the user apparatus 60 is connected to an ONU 40 without the subordinate apparatus 50 mediating communication.

Each user apparatus 60 is an apparatus that is communicably connected to other apparatuses as a result of being connected to a subordinate apparatus 50 via a communication channel. The user apparatus 60 is an information processing apparatus such as a smartphone, a tablet, or a personal computer, for example. The user apparatus 60 may also be a sensor in IoT (Internet of Things), for example. The user apparatus 60 may also be an apparatus for business use such as an ATM (Automatic Teller Machine), a vending machine, or a POS (Point Of Sale) terminal, for example.

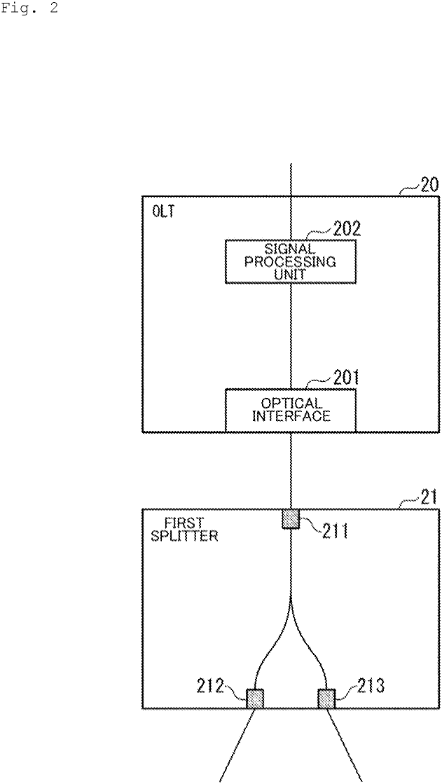

Next, the OLT 20 and the first splitter 21 will be described. FIG. 2 is a diagram illustrating an exemplary configuration of the OLT 20 and the first splitter 21. The OLT 20 includes an optical interface 201 and a signal processing unit 202. The OLT 20 is an apparatus that provides an OLT function in a known PON.

The optical interface 201 outputs an optical signal generated by the signal processing unit 202 to the first splitter 21. The optical interface 201 transmits the optical signal to the ONUs 40 via the first splitter 21 and the second splitters 30. On the optical signal transmitted by the optical interface 201, optical signals addressed to a plurality of ONUs 40 may also be superimposed.

The optical interface 201 receives an optical signal from the first splitter 21, and outputs the received optical signal to the signal processing unit 202. The optical interface 201 receives an optical signal from an ONU 40 via a second splitter 30 and the first splitter 21. On the optical signal received by the optical interface 201, optical signals transmitted from a plurality of ONUs 40 may also be superimposed.

The signal processing unit 202 functions as a known OLT. In the following, an example of processing to be performed by such a signal processing unit 202 will be described. The signal processing unit 202 converts an electric signal transmitted from the host apparatus 10 to a subordinate apparatus 50 to an optical signal, and outputs the optical signal to the optical interface 201. The signal processing unit 202 may also superimpose (multiplex) optical signals addressed to a plurality of subordinate apparatuses 50. The signal processing unit 202 converts an optical signal received by the optical interface 201 to an electric signal, and outputs the electric signal to the host apparatus 10, which is the destination.

The first splitter 21 is constituted by using an optical signal splitter. The first splitter 21 includes at least three ports (211, 212, and 213). The first splitter 21 distributes and outputs an optical signal input from the OLT 20 via the port 211 to a plurality of ports (ports 212 and port 213) connected to the trunk communication channel. The ratio of distribution of the optical signal between the port 212 and the port 213 may be an equal ratio (50:50), or may also be an unequal ratio (i.e., 40:60). The first splitter 21 puts together a plurality of optical signals that are input from the trunk communication channel via the ports 212 and 213, and outputs the resultant signal to the port 211 connected to the OLT 20.

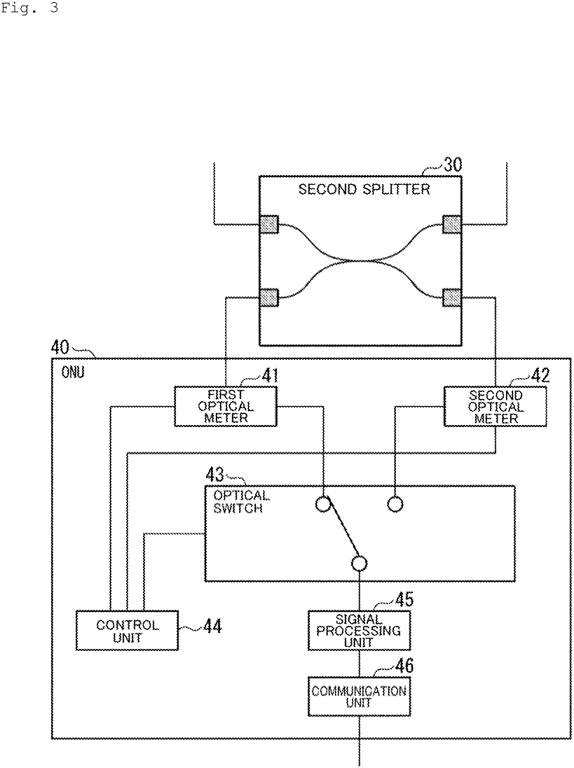

FIG. 3 is a diagram illustrating an exemplary configuration of each second splitter 30 and ONU 40. The second splitter 30 is constituted by using an optical signal second splitter with two inputs and two outputs. The second splitter 30 distributes and outputs an optical signal input from the trunk communication channel to a downstream apparatus and the ONU 40 connected to the second splitter 30. The ratio of distribution, here, may be an equal ratio (50:50), or may also be an unequal ratio (i.e., 40:60).

The downstream apparatus is an apparatus, out of two apparatuses connected to one second splitter 30 via the trunk communication channel, that is different from the apparatus that outputs an optical signal to be input to the one second splitter 30. For example, in FIG. 1, when a second splitter 30-1 is taken as a reference, in the case where an optical signal input from the first splitter 21 is to be distributed, the downstream apparatus is a second splitter 30-2. For example, in FIG. 1, when the second splitter 30-2 is taken as a reference, in the case where an optical signal input from the second splitter 30-1 is to be distributed, the downstream apparatus is a second splitter 30-3. For example, in FIG. 1, when the second splitter 30-2 is taken as a reference, in the case where an optical signal input from the second splitter 30-3 is to be distributed, the downstream apparatus is the second splitter 30-1.

Also, each second splitter 30 outputs an optical signal to be output to the ONU 40 connected to the second splitter 30, to the ONU 40 through a communication channel that differs depending on the port to which the optical signal has been input. For example, the second splitter 30 outputs an optical signal input through an upper left port in FIG. 3 to an upper right port and a lower right port. Therefore, when the second splitter 30-1 in FIG. 1 is described as an example, an optical signal input from the first splitter 21 is output to a path 91-2 and the second splitter 30-2. The optical signal output to the path 91-2 is input to an ONU 40-1. Also, the second splitter 30 outputs an optical signal input through an upper right port in FIG. 3 to an upper left port and a lower left port, for example. Therefore, when the second splitter 30-1 in FIG. 1 is described as an example, an optical signal input from the second splitter 30-2 is output to a path 91-1 and the first splitter 21. The optical signal output to the path 91-1 is input to the ONU 40-1. Note that the path 91-1 and the path 91-2 are connected to different optical meters. For example, the path 91-1 is connected to a first optical meter 41, and the path 91-2 is connected to a second optical meter 42.

Each ONU 40 includes a first optical meter 41, a second optical meter 42, an optical switch 43, a control unit 44, a signal processing unit 45, and a communication unit 46. The first optical meter 41 receives an optical signal output from the connected second splitter 30. The first optical meter 41 outputs information indicating the light intensity of the received optical signal to the control unit 44. The first optical meter 41 outputs the received optical signal to the optical switch 43. The second optical meter 42 receives an optical signal output from the second splitter 30. The second optical meter 42 outputs information indicating the light intensity of the received optical signal to the control unit 44. The second optical meter 42 outputs the received optical signal to the optical switch 43.

The optical switch 43 outputs one of the optical signal output from the first optical meter 41 and the optical signal output from the second optical meter 42 to the signal processing unit 45, in accordance with the control of the control unit 44. The optical switch 43 outputs the optical signal output from the signal processing unit 45 to the second splitter 30 via one of the first optical meter 41 and the second optical meter 42, in accordance with the control of the control unit 44.

The control unit 44 receives light intensity information from each of the first optical meter 41 and the second optical meter 42, and selects one of them in accordance with a predetermined criteria. The control unit 44 controls the optical switch 43 such that the selected optical signal is output to the signal processing unit 45. The predetermined criteria for selection is higher reliability, for example. The level of reliability may be determined based on the light intensity of the optical signal. For example, the control unit 44 may select an optical signal with higher light intensity.

A portion or the entirety of the operations of the control unit 44 may be realized using hardware including an electronic circuit in which an LSI (Large Scale Integration circuit), an ASIC (Application Specific Integrated Circuit), a PLD (Programmable Logic Device), an FPGA (Field Programmable Gate Array), or the like is used.

The signal processing unit 45 functions as an ONU in a known PON. In the following, an example of the processing of this signal processing unit 45 will be described. The signal processing unit 45 converts an optical signal indicating a signal transmitted from the host apparatus 10 to the connected subordinate apparatus 50, to an electric signal, and outputs the electric signal to the communication unit 46. Here, if optical signals addressed to a plurality of subordinate apparatuses 50 are superimposed (multiplexed), the signal processing unit 45 takes out an optical signal addressed to the subordinate apparatus 50 connected to the ONU 40 of the signal processing unit 45, and converts the taken out optical signal to an electric signal. The signal processing unit 45 converts an electric signal received by the communication unit 46 to an optical signal, and outputs the optical signal to the optical switch 43.

The communication unit 46 is a communication interface for communication with the subordinate apparatus 50.

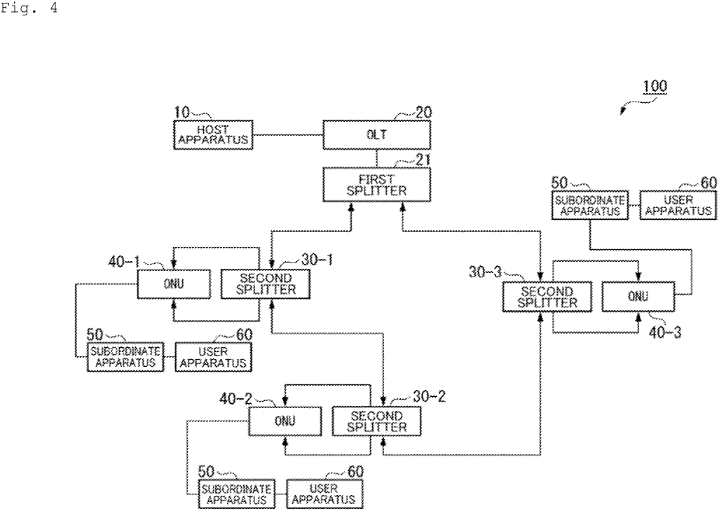

FIG. 4 is a diagram illustrating a specific example of operations of the communication system 100 at a time of normal communication. The arrows shown in FIG. 4 indicate the flow of a downstream signal (signal flowing from the host apparatus 10 to a subordinate apparatus 50). As shown in FIG. 4, in the communication system 100, as a result of arranging the first splitter 21 between the OLT 20 and the trunk communication channel, the downstream signal can be transmitted through both of a clockwise path and a counterclockwise path.

In the example in FIG. 4, a problem does not occur in the communication system 100, in particular. Therefore, the downstream signals obtained by branching made by the first splitter 21 reach the first splitter 21 through all of the second splitters 30. As a result, an optical signal transmitted through the trunk communication channel in a clockwise direction, and an optical signal transmitted through the trunk communication channel in a counterclockwise direction reach each of the ONUs 40. Each ONU 40 selects one of the optical signals in accordance with a predetermined criteria (e.g., higher light intensity), and uses the selected optical signal for processing.

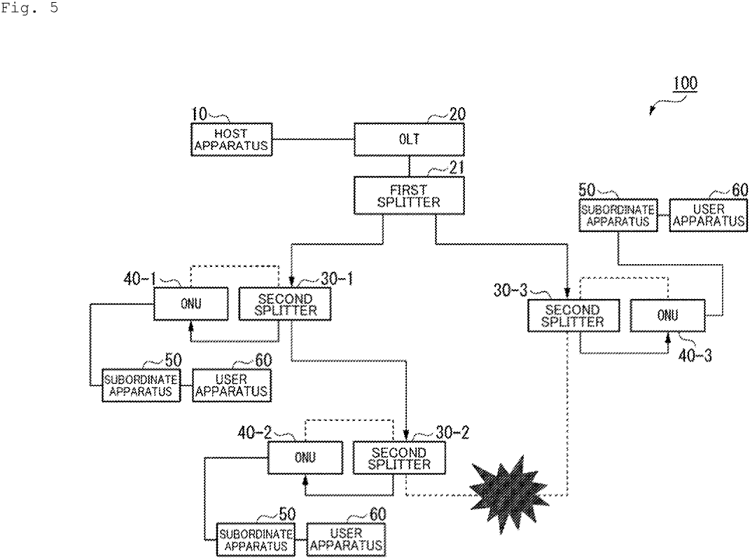

FIG. 5 is a diagram illustrating a specific example of operations of the communication system 100 at a time of troubled communication. In FIG. 5, the communication channel shown by a broken line, out of the two communication channels extending from a second splitter 30 to the connected ONUs 40, indicates a communication channel through which the optical signal (downstream signal) transmitted from the OLT 20 does not pass. The communication channels shown by solid lines with arrows indicate communication channels through which the optical signal (downstream signal) transmitted from the OLT 20 passes.

In the example in FIG. 5, a problem occurs in a communication channel between the second splitter 30-2 and the second splitter 30-3. Therefore, a downstream signal output from the second splitter 30-2 does not reach the second splitter 30-3. Similarly, a downstream signal output from the second splitter 30-3 does not reach the second splitter 30-2.

The second splitter 30-2 cannot receive an optical signal transmitted in the clockwise direction due to the occurrence of a problem, but can receive an optical signal transmitted in the counterclockwise direction. An ONU 40-2 receives the optical signal transmitted in the counterclockwise direction via the second splitter 30-2.

The second splitter 30-3 cannot receive an optical signal transmitted in the counterclockwise direction due to the occurrence of the problem, but can receive an optical signal transmitted in the clockwise direction. An ONU 40-3 receives the optical signal transmitted in the clockwise direction via the second splitter 30-3.

As a result of the operations described above, all of the ONUs (ONU 40-1, ONU 40-2, and ONU 40-3) can receive the downstream signal from the OLT 20 and can maintain communication, regardless of the occurrence of a problem.

The flow of a downstream signal has been described. An upstream signal is transmitted to the OLT 20 from each ONU 40 as a result of a signal flowing through solid line paths in the drawings described above in a direction opposite to the arrow direction. Also, in FIGS. 4 and 5, the arrows between the second splitters 30 and the connected ONUs 40 each indicate single direction, and these arrows indicate the flow direction of a downstream signal. In the case of an upstream signal, the signal is transmitted using the paths selected by the optical switches 43.

In the communication system 100 configured as described above, an optical signal output from the OLT 20 is distributed to a plurality of paths by the first splitter 21, and transmits through the trunk communication channel. For example, the downstream signal is transmitted through two paths, namely a clockwise path and a counterclockwise path. As a result, even if a problem occurs in a communication channel or the like, the likelihood that the ONUs 40 can each receive an optical signal from one of the paths increases. Therefore, even if a problem occurs in the PON, the likelihood of being able to maintain communication can be increased.

Although an embodiment of the present invention have been described with reference to the drawings, the specific configuration is not limited to the embodiment, and designs or the like that do not depart from the gist of the invention are intended to be within the scope of the invention.

### INDUSTRIAL APPLICABILITY

The present invention can be applied to a system for performing communication using the PON.

Reference Signs List

| | |
|---|---|
| 100 | Communication system |
| 10 | Host apparatus |
| 20 | OLT |
| 21 | First splitter |
| 30 | Second splitter |
| 40 | ONU |
| 50 | Subordinate apparatus |
| 60 | User apparatus |
| 201 | Optical interface |
| 202 | Signal processing unit |
| 211 to 213 | Port |
| 41 | First optical meter |
| 42 | Second optical meter |
| 43 | Optical switch |
| 44 | Control unit |
| 45 | Signal processing unit |
| 46 | Communication unit |

1. A communication system for a passive optical network, comprising:
an OLT (Optical Line Terminal);
a first splitter configured to output an optical signal that is output from the OLT, to optical communication channels from a first port and a second port;
a plurality of second splitters that are connected between the first port and second port of the first splitter using optical communication channels; and
ONUs (Optical Network Units) that are connected to respective second splitters using optical communication channels.

2. The communication system according to claim 1, wherein each second splitter distributes and outputs an optical signal transmitted from the OLT to the ONU connected to the second splitter and another second splitter or the OLT.

3. The communication system according to claim 2,
wherein each second splitter outputs the optical signal to the connected ONU through two paths, and
each ONU selects one of the optical signals received through the two paths based on a predetermined criterion, and performs processing on the selected optical signal.
